(19) United States
(12) Patent Application Publication
(10) Pub. No.: US 2014/0335816 A1
(43) Pub. Date: Nov. 13, 2014

(54) Key fob communicator

(71) Applicant: Jesse Wayne Long, Hobbs, NM (US)

(72) Inventor: Jesse Wayne Long, Hobbs, NM (US)

(21) Appl. No.: 13/892,368

(22) Filed: May 13, 2013

(51) Int. Cl. H04W 88/02

(52) U.S. Cl. CPC H04W 88/02
USPC 455/406; 455/564

(57) ABSTRACT

The invention is directed to a key fob that offers limited communication ability to out-dial 911 and allows two-way communication with the 911 operator. The key fob also incorporates various embodiments with a small keypad. The key fob also incorporates various embodiments with a small keypad whose function may integrated with a vehicle remote-keyless entry system. Business methods and practices, formulated to provide limited cellular telephone service to the key fob user at the lowest possible cost including free emergency services calls, are incorporated.

Not Applicable

### BACKGROUND OF THE INVENTION

The invention relates generally to an emergency communication device, and in particular to a key fob that offers limited communication ability to out-dial 911 and allows two-way communication with the 911 operator. Commuters and other drivers of vehicles may find themselves in a situation where they need to call 911, due to an automobile accident or other emergency situation that would require the assistance of 911. If the user does not have access to a cellular telephone or other means of contacting 911, or if the user is injured in an accident and unable to use a cellular telephone, the emergent situation may become life threatening or may leave the user otherwise stranded, with no way to obtain the assistance needed. A key fob that offers limited communication ability to out-dial 911 and allows two-way communication with the 911 operator, who will provide assistance to those users who may need it, would substantially reduce these risks. Certain business methods and practices, formulated to provide cellular telephone service that is adequate for these limited purposes to the key fob user at the lowest possible cost, would make this emergency communication device an option for almost anyone.

### SUMMARY OF THE INVENTION

Accordingly, the invention is directed to a key fob that offers limited communication ability to out-dial 911 and allows two-way communication with the 911 operator. The key fob also incorporates various embodiments with a small keypad whose function may integrated with a vehicle remote-keyless entry system. Business methods and practices, formulated to provide cellular telephone service that is adequate for these limited purposes to the key fob user at the lowest possible cost, including free emergency services calls, are incorporated into this invention.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a top view of the first exemplary embodiment with the activation button shown in a guarded position, showing the key fob communicator body 100, the button guard 101, the slide rails 102, the internal/opposite-facing dome antenna 103, the speaker 104, the activation button 105, the microphone 106, the key attachment 120, the key ring 121, and the key 122.

FIG. 2 shows a top view of the first exemplary embodiment with the activation button shown in an unguarded position, showing the key fob communicator body 100, the button guard 101, the slide rails 102, the internal/opposite-facing dome antenna 103, the speaker 104, the activation button 105, the microphone 106, the key attachment 120, the key ring 121, and the key 122.

FIG. 3 shows a bottom view of the first exemplary embodiment, showing the key fob communicator body 100, the dome antenna 103, the key attachment 120, the key ring 121, and the key 122.

FIG. 4 shows a side view of the first exemplary embodiment, showing the key fob communicator body 100, the dome antenna 103, the key attachment 120, the key ring 121, and the key 122.

FIG. 5 shows a top view of the second exemplary embodiment with a small keypad, showing the key fob communicator body 500, the dome antenna 503, the keypad 510, the key attachment 520, the key ring 521, and the key 522.

FIG. 6 shows a side view of the second exemplary embodiment with a small keypad, showing the key fob communicator body 500, the dome antenna 503, the keypad 510, the key attachment 520, the key ring 521, and the key 522.

FIG. 7 shows a flow chart diagram of a method of providing the first exemplary embodiment at retail sale.

FIG. 8 shows a flow chart diagram of a method of providing the second exemplary embodiment at retail sale.

### DETAILED DESCRIPTION OF THE INVENTION

As required, detailed embodiments of the present invention are disclosed herein; however, it is to be understood that the disclosed embodiments are merely exemplary of the invention that may be embodied in various and alternate forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

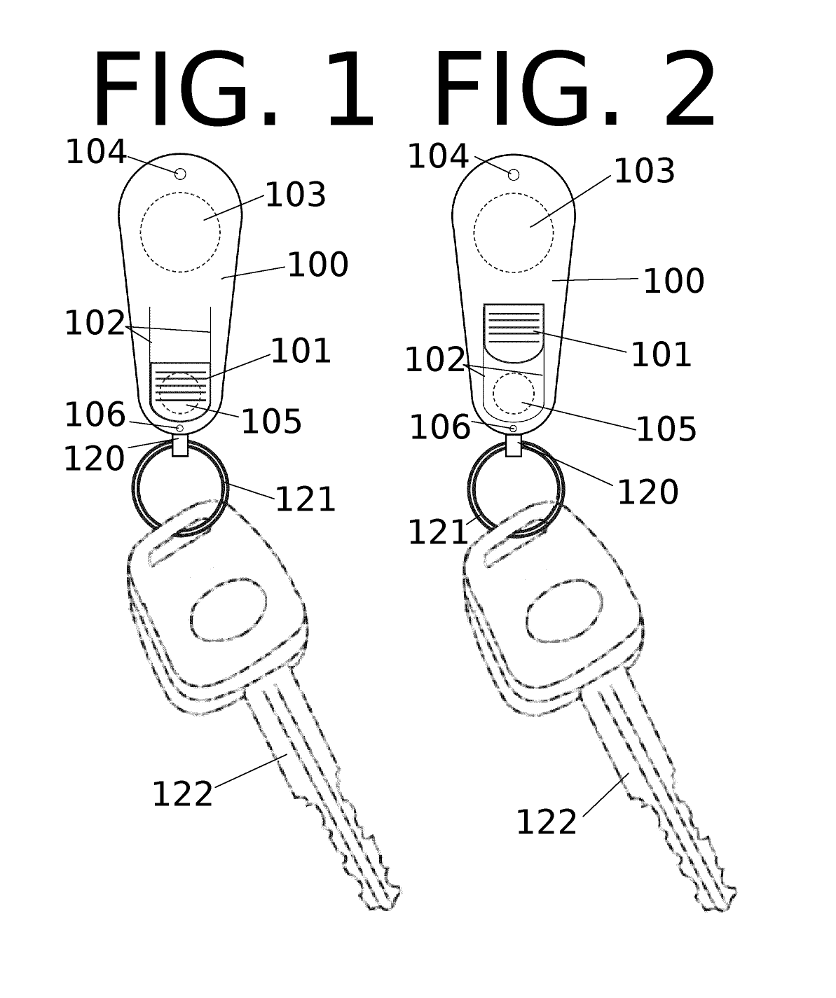

Referring now to the invention in more detail, the invention is directed to a key fob communicator that offers limited communication ability to out-dial 911 and allows two-way communication with the 911 operator. In the first exemplary embodiment illustrated in FIGS. 1-2, the key fob communicator may be configured to call a telephone number using standard communication technologies. Exemplary communication modes for the key fob communicator include cellular service, both digital and analog, and other radio-based modes typically utilized in mobile telephone technologies. For simplicity, the description contained herein refers to the key fob communicator as using cellular telephone communication technology in accommodation of most persons' familiarity with this terminology, and easy recognition of the implementation that is described.

The key fob communicator would be operable within at least one cellular telephone network in the region of its intended use. It may be possible that the key fob communicator may operate on multiple cellular telephone networks. However, depending on its use, a service contract for a particular cellular network may be necessary in order to place calls from the key fob communicator.

In the exemplary embodiment, the key fob communicator is dedicated exclusively for communication with emergency numbers. In the context of this invention, emergency telephone numbers may include emergency services as well as other telephone numbers dialed in emergency situations, as defined and specified by the user, either pre-purchase or pre-manufacture of the key fob communicator. For example, emergency numbers for an elderly user may include police, the fire department, an ambulance service, a home care nursing service, or a family member who lives nearby. Similarly, emergency numbers for a child may include any emergency contacts such as the fire department, police, a school counselor, or the home and cellular telephone numbers of the child's parents. Emergency numbers for a recovering addict may include not only the fire department and police, but also an addiction counselor, a Narcotics Anonymous sponsor, or a family member. All numbers except 911 or 311 would be pre-paid at purchase.

In the first exemplary embodiment, the key fob communicator may be exclusively dedicated for communication with the emergency telephone number 911, or its regional equivalent. In this 911-only embodiment, the key fob communicator may not require a service contract with a cellular service network. In many areas, emergency calls to 911 using a cellular telephone device must be connected regardless of whether the cellular telephone device has an active service plan.

In addition to being pre-programmed for calling a single number and activated by a single button, it is contemplated that the key fob communicator can be further programmed or otherwise adapted to repeatedly dial the called party until reached, or until another precondition is met. An example of such a precondition would be a specified number of redials being performed without making contact, or a prescribed period of redial time expiring without contact.

The key fob communicator body 100 may be shaped and designed to efficiently function as a traditional key fob. The key attachment 120 would connect a key, set of keys, or tether strap to the key fob communicator 100. While the preferred embodiment would include a key attachment 120, one of ordinary skill in the art would readily understand that many different mechanisms and attachments might be used to connect to the key fob communicator body 100.

The key fob communicator body 100 also functions to stow the micro-circuit communications elements of the key fob communicator. In FIGS. 1-2, the key fob communicator body 100 holds the button guard 101, the slide rails 102, the antenna 103, the speaker 104, the activation button 105, and the microphone 106. Other electronic components would include a processor and a memory device, internal to the key fob communicator body 100. The speaker 104 and the microphone 106 may be configured to function as a standard cellular telephone. The button guard 101 is positioned on a pair of slide rails 102, and slidably moves between the shielded position, covering the activation button 105, and an unshielded position, uncovering the activation button 105.

The key fob communicator may also have markings and phrases on the key fob communicator body 100, indicating its purpose and the number to be dialed. Markings such as EMERGENCY 911 may serve to inform and alert the user and others to the emergency use and nature of the key fob communicator. Such markings may be important if the user is incapacitated by illness or injury, or otherwise incapable of communicating the emergency use of the key fob communicator to others.

The key fob communicator would include a power source internal to the key fob communicator body 100, and normally in the form of a conventional or lithium ion battery, either permanently installed with or without recharging ability with a separate adapter cord, or user replaceable. In a permanent power source embodiment without recharging ability, the battery could be sized to support a single, full power emergency telephone call and the device could be considered a one-time disposable emergency communication device.

In the first exemplary embodiment, the button guard 101 would control the connection between the power source and the key fob communicator. The button guard 101 would preferably be configured to place the device in a power-off condition when the button guard 101 is in the shielded position. In this power-off condition, the key fob communicator is disabled. The button guard 101 would preferably also be configured to place the device in a power-on condition when the button guard 101 is in the unshielded position. In this power-on condition, the key fob communicator may transmit and, in embodiments that include a speaker 104, receive signals.

Upon activation, the activation button 105 enables the device to communicate. In all embodiments, the device is limited to outgoing calls only. The device may additionally be limited to outgoing calls for emergency numbers only. While the activation button 105 as shown in FIGS. 1-2 is a push-button type activation device, it is not intended to be limiting; one of ordinary skill in the art would readily understand that many different types of devices might be implemented in the device to function as the activation button 105. For example, the activation button 105 could be replaced with a switch, a contact sensor, or one of many other well-known devices and still function within the scope of the present invention.

In the second exemplary embodiment, the device is exclusively limited to dialing outgoing calls to the emergency number 911, or a regional equivalent, upon actuation of the activation button 105. The single activation button 105 configuration enables the user to quickly and efficiently dial an emergency number without having to manipulate a complex and typically small keypad. By using one button dialing, the misdialing of the emergency number may be avoided and the activation time for initiating an emergency call may be reduced, which are important considerations in an emergency situation.

In all embodiments, in addition to providing full-duplex voice communication, the key fob communicator may also receive requests for information from a communication system with which the key fob communicator is communicating, but only after a call has been initiated and established from the key fob communicator. For example, the called system may request the status of a limiting condition for the key fob communicator, such as how much longer the user can remain connected to the system, and the key fob communicator would respond with an appropriate pre-recorded message such as “two minutes of air time remain available.” This response from the key fob communicator would be transmitted in both vocal format and data stream format, to be interpreted by the requesting system at the dialed number. This type of capability is particularly important in emergency situations, where such data may be interpreted when determining proper responses to be made by emergency personnel.

In the shielded position and power-off condition, the button guard 101 may function to prevent inadvertent dialing, power supply depletion, or damage to the activation button 105. In FIGS. 1-2 the button guard 101 is slidably attached on a pair of sliding rails 102, however the button guard 101 may be attached to the key fob communicator body 100 in any one of several other suitable ways, as long as the button guard 101 requires positive user input. Examples include sliding, rotating, pivoting, disengagement, or breakage. Likewise, a button guard 101 in the form of a flip cover, destructible cover, removable cover, or other equivalent device is also contemplated. The action of transitioning from the shielded position to the unshielded position, and placing the emergency call, would be easily performed by the user with a single positive input and manual engagement of the exposed top surface of the activation button 105. However, the resistance offered by the button guard 101 must be sufficient to prevent transitioning to the unshielded position by mere abutment with other objects, such as those carried in the user's pocket or purse, or in a vehicle's glove compartment or center console.

Some contemplated embodiments of the device would include a Global Positioning System receiver and, in some embodiments, a GPS transmitter. The GPS transmitter and receiver are operable in conjunction with the well-known GPS satellite system to determine geolocation of the activated key fob communicator, and consequently the location of the user. Additionally, the GPS receiver may be interfaced with the device's cellular communication system, in such a manner as to communicate the geolocation of the device to the recipient of an emergency call from the device. The geolocation communication may be in the form of a transmission from the device, either automatically or in response to a request from the recipient of the call, such as a 911 operator.

The key fob communicator may be operative to respond automatically to requests with the geolocation communication. Preferably, the geolocation would be sent both in oral format and as a data stream, to be interpreted by the communication system at the dialed number. If the key fob communicator does not have a GPS receiver, or if geolocation is unavailable or indeterminable, the key fob communicator may be configured to respond to a request for geolocation with responses indicating this condition, such as “no geolocation available.”

In all exemplary embodiments shown in the attached illustrations, the key fob communicator body 100 holds an antenna 103, specifically a flat dome style antenna. The illustrations are not intended to be limiting; one of ordinary skill in the art would readily understand that many different types of devices might be implemented in the key fob communicator to function as the antenna 103. However, the flat dome style enables the antenna 103 to be completely enclosed within the key fob communicator body 100, allowing the key fob communicator to easily and comfortably fit within the user's pocket or purse. It is contemplated that alternate versions may incorporate the antenna 103 into the key fob communicator body 100 in a protrusion-free manner, or be extended from and retracted into the key fob communicator body 100, so long as the antenna 103 functions to connect the key fob communicator to an available cellular network.

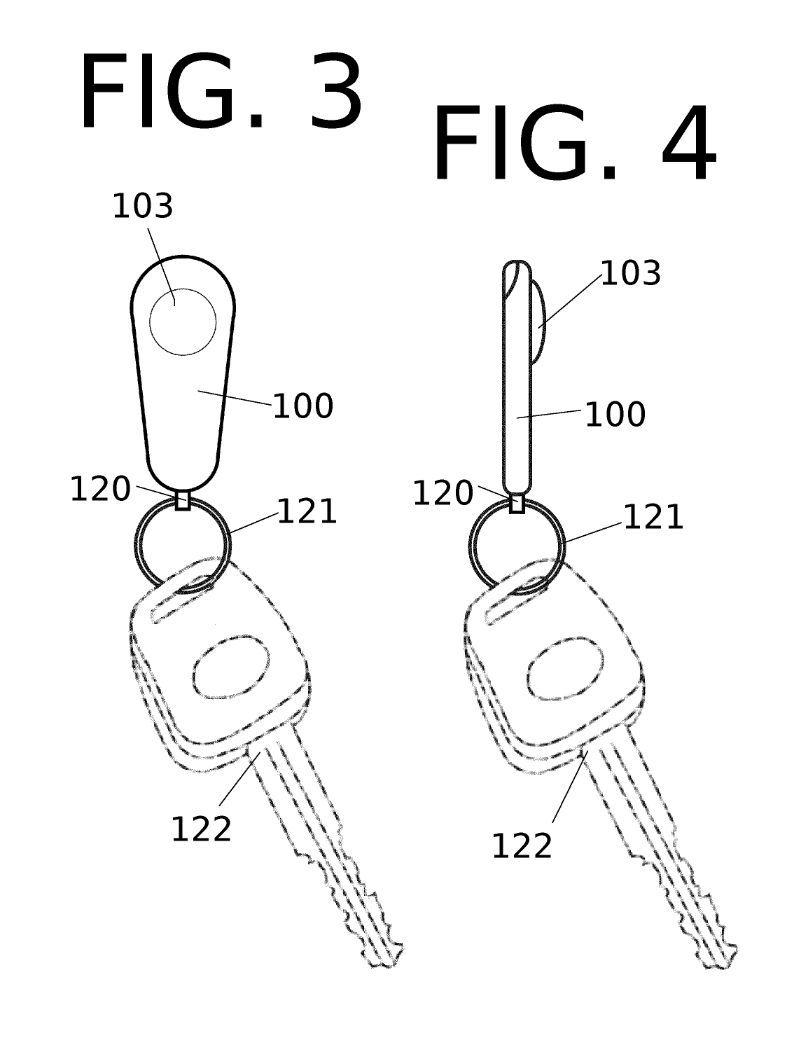

The second exemplary embodiment, illustrated in FIGS. 3-4, transmits a voice message from the user. It would only be capable of transmitting a recorded emergency message, along with geolocation obtained from the GPS system.

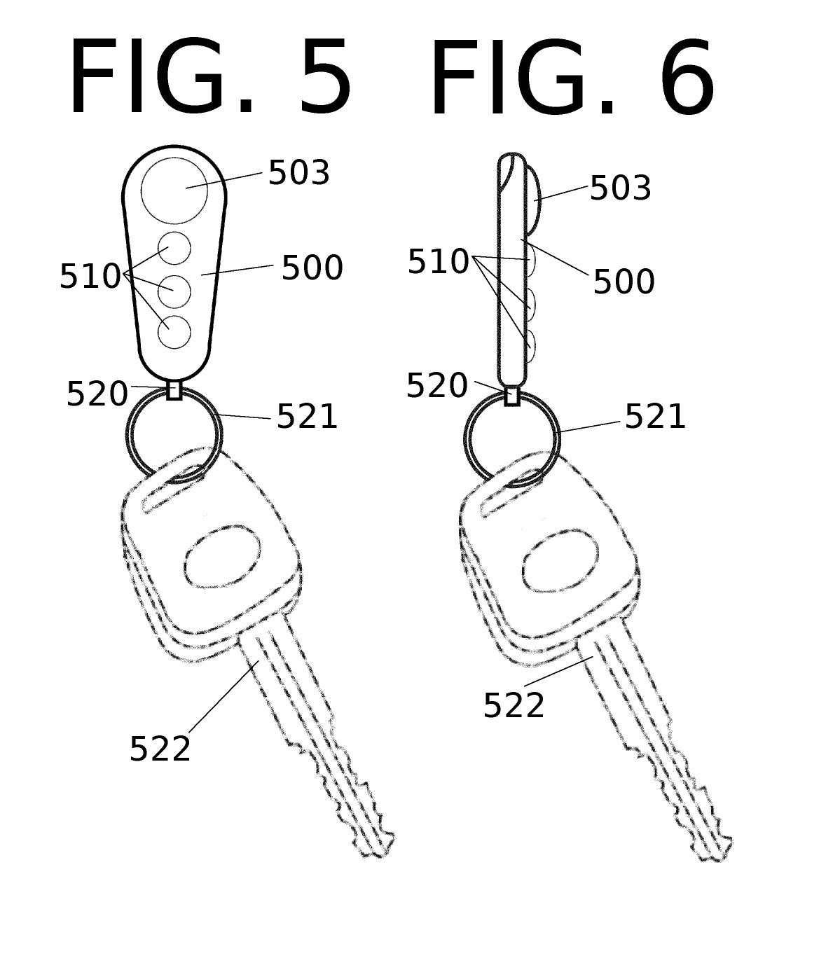

The present invention incorporates various embodiments with a small keypad 510, which would be intended to operate a vehicle remote keyless entry/remote-starter system. These embodiments include the second exemplary embodiment illustrated in FIGS. 5-6. While the keypad buttons as shown in FIGS. 5-6 are of the push-button type, they are not intended to be limiting; one of ordinary skill in the art would readily understand that many different types of devices might be implemented in the device to function as the buttons on the keypad 510. For example, the keypad buttons could be replaced with switches, contact sensors, or one of many other well-known devices and still function within the scope of the present invention.

The present invention also incorporates various embodiments embedded in vehicle key fobs that interface with vehicle remote keyless entry and remote starter systems. Such embodiments would be provided with a keypad in addition to the emergency call activation button, and the keypad buttons would provide all of the usual functionality associated with vehicle remote keyless entry and remote start systems.

Such embodiments may be supplied with new vehicles by vehicle manufacturers or dealers, or may be provided on an after-market basis as enhanced replacement key fobs for lost or inoperable remote keyless entry/remote start fobs. FIG. 8 shows a method of providing such embodiments to the consumer at retail. According to such embodiments, the device, once manufactured, is sold or transferred to a vehicle manufacturer or dealer where it is linked to the remote keyless entry/remote-starter system of a new vehicle. This would enable the recipient of an emergency call from the key fob communicator to remotely allow keyless entry to the vehicle by the user. Any anticipated call charges are prepaid at the time of manufacture or at the time of sale, and the costs ultimately passed on to the consumer through the purchase price.

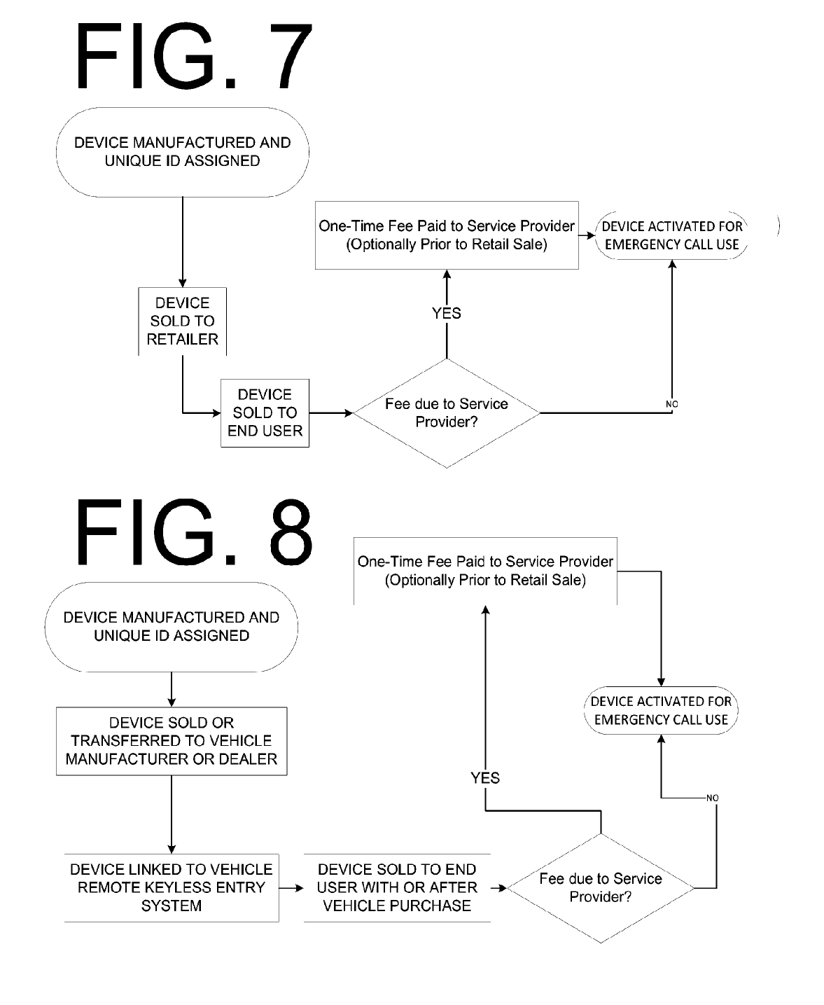

By contrast to embodiments that interface with a vehicle remote keyless entry/remote-starter system, the first exemplary embodiment is intended for standalone use. FIG. 7 illustrates a method of providing the first exemplary embodiment at retail. The first exemplary embodiment, once manufactured and provided with mobile calling functionality is sold or transferred directly to a retailer for sale. Any anticipated call charges are prepaid at the time of manufacture or at the time of sale, and the costs are ultimately passed on to the consumer throught he purchase price.

The key fob communicator would be operable within at least one cellular telephone or radiotelephone network in the region of its intended use and, if not used exclusively for emergency calls, direct charges for its use would be pre-paid. Examples of charged calls include contemplated embodiments where the single-dialed number is not to public emergency services, but to a private emergency assistance service or security service, or to a single telephone number preprogrammed or pre-designated by the user, as well as embodiments intended for use in jurisdictions where mobile calls to public emergency services are not required to be free of charge. The key fob communicator is characterized by a set of limiting events including: the end of a preset number of completed calls; the expiration of a preset amount of air time; and/or the occurrence of a preset expiration date. The key fob communicator is of no operational use to the user after occurrence of the earliest limiting event, unless and until pre-paid use is refreshed. In this alternate embodiment, the key fob communicator remains disposable or refreshable at the user's discretion, but interface with the provider of the key fob communicator would be required for refreshment. In this sense, operation of the key fob communicator may still be limited, without requiring that it be disposable.

All direct charges for use of the key fob communicator would be pre-paid. Further, operation of the key fob communicator may be characterized, for example, by a set of limiting events or conditions that may include: the end of the elapsed operational life of the batteries; the end of a preset number of completed calls; the expiration of a preset amount of air time; and/or the occurrence of a preset expiration date. In a particularly preferred embodiment, the key fob communicator is of no operational use to the user after the earliest occurrence of any one of these limiting events or conditions.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A key fob communicator comprising:
(a) a key fob body;
(b) a receiver configured to accept connection of a key to the key fob body;
(c) a single activation button located on the exterior of said key fob body;
(d) a speaker disposed within said key fob body;
(e) a microphone disposed within said key fob body;
(f) an antenna disposed within said key fob body;
(g) said key fob communicator being operable within at least one cellular telephone network upon activation of the single activation button;
(h) said key fob communicator being operable upon activation to dial a single preset telephone number and operable only for such outgoing calls to said single preset telephone number;
(i) a button guard;
(j) said button guard being slidably affixed to said key fob body;
(k) said button guard in located in a primary position over said single activation button, and said button guard being slidable into a secondary positions such that said single button is exposed; and
(l) said key fob communicator being in a power-off configuration when said button guard is in said primary position, and said key fob communicator being in a power-on configuration when said button guard is in said secondary position.

2. The key fob communicator of claim 1, wherein said single preset telephone number is a telephone number that is of use in an emergency as to the particular user.

3. The key fob communicator of claim 2, wherein said single preset telephone number is a free-of-charge number associated with public emergency services.

4. The key fob communicator of claim 1 wherein said single preset telephone number requires the payment of a calling charge to a mobile telephone network operator.

5. The key fob communicator of claim 4 wherein all charges for a predetermined number of calls or length of talk-time are prepaid and included in the cost of said key fob communicator to a user-purchaser.

6. The key fob communicator of claim 1, further comprising a Global Positioning System (GPS) receiver adapted for cooperation with GPS satellites for determining the geolocation of the activated key fob communicator.

7. The key fob communicator of claim 6, wherein said key fob communicator is configured to transmit the geolocation of the activated key fob communicator to the recipient of an outgoing call.

8. The key fob communicator of claim 1, wherein no buttons other than said single activation button are present.

9. The key fob communicator of claim 1, wherein said key fob communicator is configured to use replaceable batteries.

10. The key fob communicator of claim 1, wherein said key fob communicator is configured to use a permanently installed, rechargeable battery.

11. The key fob communicator of claim 1, wherein said key fob communicator is intended to be disposable, and configured to use a permanently installed battery that cannot be recharged.

12. The key fob communicator of claim 1, further comprising a keypad having a plurality of buttons other than said activation button, said buttons being configured to interoperate with the remote keyless entry system or remote starter system of a particular vehicle.

13. The key fob communicator of claim 11, further comprising a keypad having a plurality of buttons other than said activation button, said buttons being configured to interoperate with the remote keyless entry system or remote starter system of a particular vehicle.

14. A business method for managing pre-paid cellular communication service through the key fob communicator of claim 1, comprising:
(a) prepayment of all anticipated call charges to a mobile carrier at the time of manufacture or at the time of sale; and
(b) passing the cost of said prepayment to a retail purchaser of said key fob communicator as a part of the purchase price paid by said retail purchaser.

15. The business method of claim 15, further comprising:
(a) a set of limiting events or conditions that may include the end of the elapsed operational life of the batteries, the end of a preset number of completed calls, the expiration of a preset amount of air time, and/or the occurrence of a preset expiration date; and
(b) the end of operational use after the earliest occurrence of any one of these limiting events or conditions, until the pre-paid service plan is refreshed.

16. The business method of claim 16, further comprising:
(a) providing said key fob communicator after manufacture to a vehicle manufacturer or dealer;
(b) said vehicle manufacturer or dealer associating said key fob communicator with the remote keyless entry or remote starter system of a particular vehicle; and
(c) combining the purchase of retail sale of said key fob communicator to said retail purchaser with the sale of the particular vehicle with which said key fob communicator is associated to said retail purchaser.
